(19) United States
(12) Patent Application Publication
(10) Pub. No.: US 2010/0224049 A1
(43) Pub. Date: Sep. 9, 2010

(54) Guitar Capo With Rotatable Member

(76) Inventor: JOHN TRAN, TUSTIN, CA (US)

Correspondence Address: ARDENT LAW GROUP, P.C., 2600 Michelson, Ste. 1700, Irvine, CA, 92612, US

(21) Appl. No.: 12/351,667

(22) Filed: Jan. 9, 2009

Related U.S. Application Data
(60) Provisional application No. 61/021,393, filed on Jan. 16, 2008.

(51) Int. Cl. G10D 3/04

(52) U.S. Cl. 84/318

(57) ABSTRACT

The inventive subject matter which provides a capo for a stringed musical instrument comprising of a rotatable member containing at least one capo configuration which the user can select different capo configurations by turning the rotatable member either clockwise or counter-clockwise. The capo of the inventive subject matter comprising of a first portion, second portion, a rotatable member comprising of at least one capo configuration. Each capo configuration being comprised of an elastomeric-like pad. The rotatable member being interchangeable to allow the possibilities of different capo configurations.

### CROSS-REFERENCE APPLICATIONS

This application claims priority based on the provisional application No. 61/021,393 with the corresponding filing date of Jan. 16, 2008, which is hereby incorporated by reference in its entirety.

### BACKGROUND OF THE INVENTION

It can be appreciated that guitar capos have been around for many years. Guitar capos are generally used for acoustic and electric guitars and are used to change the key and pitch of the open strings of a guitar without having to adjust the strings with the tuning keys. The pitch of fretted notes does not change, only the open, unfretted strings are affected. A standard guitar capo typically covers all the strings of a regular six-string guitar. However, modernly, a variety of guitar capos have been developed which allows the guitar capo to cover only a select number of strings depending on the particular desired use.

### SUMMARY OF THE INVENTION

1. Field of the Invention

The inventive subject matter generally relates to capos for stringed, musical instruments, such as but not limited to a guitar.

2. Description of the Prior Art

It can be appreciated that capos have been designed in a variety of ornamental and structural configurations, including spring loaded capos such as but not limited to U.S. Pat. No. 4,583,440 (Powell), gear driven capos such as U.S. Pat. No. 6,459,025 (D'Addario), and adjustable screw driven capos such as U.S. Pat. No. 4,250,790 (Shubb), all hereby incorporated by reference in their entireties. Typically, a standard guitar capo will act to clamp down on all strings of the musical instrument to the fretboard of the instrument.

Recently, new capo configurations have been introduced that allows capos to be altered in a certain way as to only clamp down certain strings on a fretboard while allowing other strings to remain unclamped such as U.S. Pat. No. 5,623,110 (Hoglund), and U.S. Pat. No. 4,183,279 (Shabram), both of which are hereby incorporated by reference in their entireties. Hoglund discloses a quick setting, variable, chord forming partial capo which incorporates a sliding bar containing string depressors that allow the user to select which strings to engage. Shabram discloses a variable chord-forming capo attached by a strap to the neck of the instrument. In typical use, eccentric disks may be rotated to engage or disengage from each string. Both Hoglund and Shabram suffer from limitations resulting from being very awkward and time consuming to use the capo. In addition, the ability to individually select each string engagement, although useful, often creates too many choices and variations which complicate the practical uses of each capo. Such capo configurations are commonly termed “short cut capos, or partial capos (herein collectively “cut capos”). The term cut capo derives from the fact that certain portions of a standard six-string guitar capo is modified or “cut” out to allow certain strings to be urged into contact with the fret board of the stringed instrument but whereby allowing the remaining strings to be not urged into contact with the fret board of a stringed instrument. By doing this, the cut capo can affect the tonal qualities of certain strings and leave the tonal qualities of the remaining strings unaffected.

These types of cut capos are advantageous because it allows different tunings and chord sounds otherwise impossible to obtain without physically re-tuning certain strings of the musical instrument, which is very time consuming, impractical and inefficient. In addition, by engaging fewer than all strings with a selected fret, enables a musician to form chords and sequences of notes that would be difficult or impossible to play otherwise. Furthermore, cut capos provide access to alternate tunings such as DADGAD tuning which allow the user to play simplified chord positions and achieve different sounds as opposed to regular tuned musical instruments. Other common cut capos used in the industry are termed “drop-d capos” and “open g capos,” as well as other names which describe which strings remain open or unclamped. It can be appreciated that there are virtually limitless possibilities when it comes to alterative tunings for stringed instruments.

However, although the above capos maybe adequate for the purpose it was created, the problem still exists of requiring the player to use and carry multiple different capos to achieve the advantages of each different capo configuration, including both standard capo configurations and various cut capo configurations. Therefore the need exists to have a single capo that contains multiple capo configurations that can be easily adjusted and selected. In particular, the need exists to have a single capo that contains at least one capo configuration which can be rotatably selected to provide for an easy and quick method of selecting different capo configurations.

In these respects, the capo for a stringed musical instrument according to the inventive subject matter substantially departs from the conventional concepts and designs of the prior art, and in so doing provides a capo for a stringed instrument that is not anticipated, rendered obvious, suggested, or even implied by any of the prior art capos, either alone or in combination thereof

It is therefore an object of the inventive subject matter to provide a capo for a stringed, musical instrument which is easily attached to and adjusted on the musical instrument and which contains at least one capo configuration that can be selected quickly and easily.

It is another object of the inventive subject matter to provide a capo for a stringed musical instrument with a rotatable member, comprising of at least one capo configuration, which allows the user to select different capo configurations by turning the rotatable member either clockwise or counter-clockwise. Each capo configuration urges certain strings onto the fret of the stringed instrument.

It is another object of the inventive subject matter to provide for a capo that is lightweight, compact, portable and eliminates the limitation for players to purchase and use multiple capos to achieve different capo configurations, whereby the inventive subject matter aims to provide an all-in-one multi-purpose capo.

It is another object of the inventive subject matter to provide a capo for a stringed musical instrument which is easy to manufacture and adapted for use on a variety of different musical stringed instruments having necks of different diameters.

It is another object of the inventive subject matter to provide a capo for a stringed musical instrument in which the rotatable member contains at least one capo configuration. In one embodiment, each capo configuration is comprised of an elastomeric-like pad.

It is another object of the inventive subject matter to provide a capo for a stringed musical instrument in which the rotatable member containing the capo configurations is replaceable and interchangeable thereby providing an unlimited number of capo configurations on different rotatable members.

It is another object of the inventive subject matter to provide a capo that is designed to facilitate the fingering of strings above as well as below the capo.

It is another object of the inventive subject matter to provide a capo for a stringed instrument that provides a locking mechanism for the rotatable member which unlocks to allow the user to turn the rotatable member until the desired capo configuration is selected and locks the rotatable member in place when the desired capo configuration is selected.

A capo formed in accordance to the above objects of the inventive subject matter, which incorporates some preferred features, comprising generally of a first portion, a second portion, and a rotatable member. Said rotatable member consisting of at least one capo configuration is adapted to extend above the strings and urging said strings into contact with at least one fret of a stringed instrument. The first portion comprising of a top handle and second portion comprising of a bottom handle. The second portion engages the back of the neck. The rotatable member comprising of at least one capo configuration and capable of being rotated clockwise or counter-clockwise.

The capo of the inventive subject matter including a biasing means for allowing the first portion and the second portion to apply opposite pressure on said fret and said neck of said stringed instrument; said biasing means comprising a tension coiled spring.

The capo of the inventive subject matter also comprising of a pivotal connection to pivotally interconnect the first portion to said second portion, such that the arms can be pivoted relative to each other in order to, in use, fit and position the strings and neck between said arms.

In this respect, before explaining at least one embodiment of the invention in detail, it is to be understood that the invention is not limited in its application to the details of the construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

To accomplishment of the above and related objects, the inventive subject matter may be embodied in the form illustrated in the accompanying drawings, attention being called to the fact, however, that the drawings are illustrative only, and that changes may be made in the specific construction illustrated.

### BRIEF DESCRIPTION OF THE DRAWINGS

FIG. 1 is an exploded view of an embodiment of the inventive subject matter;

FIG. 2 is a perspective view of an embodiment of the inventive subject matter;

FIG. 3 is a side view of an embodiment of the inventive subject matter;

FIG. 4 is a top down view of an embodiment of the inventive subject matter;

FIG. 5 is a bottom view of an embodiment of the inventive subject matter;

FIG. 6 is a back view of an embodiment of the inventive subject matter;

FIG. 7 is a front view of an embodiment of the inventive subject matter;

FIG. 8 is a side view of an embodiment of the rotatable member of the inventive subject matter in its standard capo configuration;

FIG. 9 is a side view of an embodiment of the rotatable member of the inventive subject matter in its cut capo configuration;

FIG. 10 is a side view of an embodiment of the rotatable member of the inventive subject matter in its drop-d capo configuration;

FIG. 11 is a side view of an embodiment of the rotatable member of the inventive subject matter in its open capo configuration

FIG. 12 is a perspective view of an embodiment of the locking mechanism of the inventive subject matter at its locked position;

FIG. 13 is a perspective view of an embodiment of the locking mechanism of the inventive subject matter at its unlocked position;

### DETAILED DESCRIPTION OF THE DRAWINGS

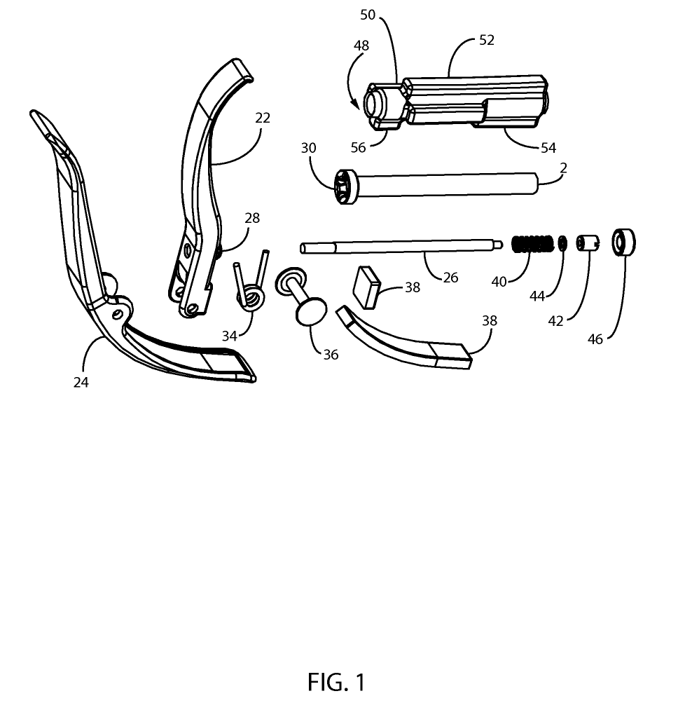

Turning to FIG. 1, one preferred embodiment of a capo of the inventive subject matter comprising a first portion 22, a second portion 24, a sus pole 26, locking protrusion with cross ribs 28, a locking mechanism 30, a capo stem 32, a coil spring 34, a rivet 36, rubber pads 38, a compression spring 40, a thumb screw 42, washer 44, screw cap 46, a rotatable member 48. The rotatable member comprising of a regular capo configuration 50, a drop-d capo configuration 52, a cut capo configuration 54, and an open capo configuration 56. The cross ribs of the locking protrusion 28 intersects with the locking mechanism 30 which is coupled to the end of the capo stem 32 and which has corresponding recesses that fit the cross ribs 28 and locking the rotatable member 48 into a selected position.

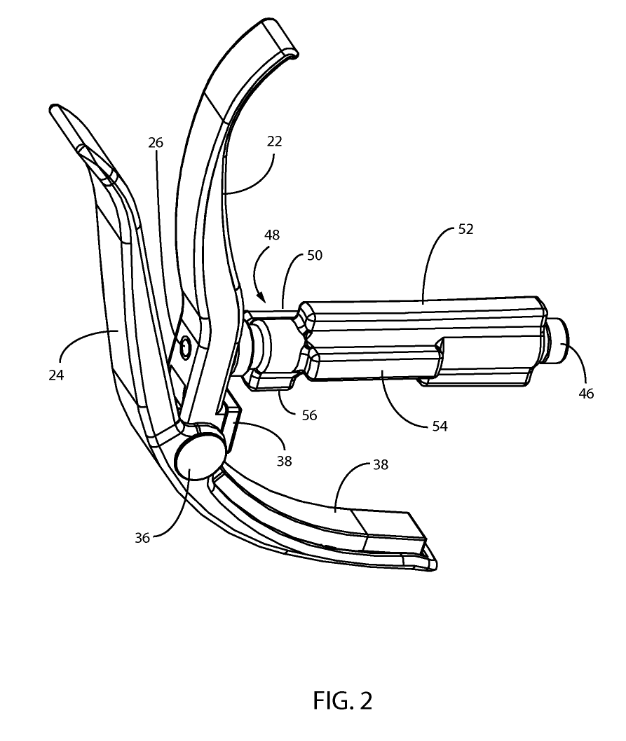

As seen in FIG. 2, the first portion 22 is pivotally coupled to second portion 24 by a rivet 36. The first portion 22 also extends to become a top handle portion and the second portion 24 extends further to become a bottom handle portion. The rotatable member 48 is coupled to the first portion 22 via the sus pole 26 which extends through the first portion 22.

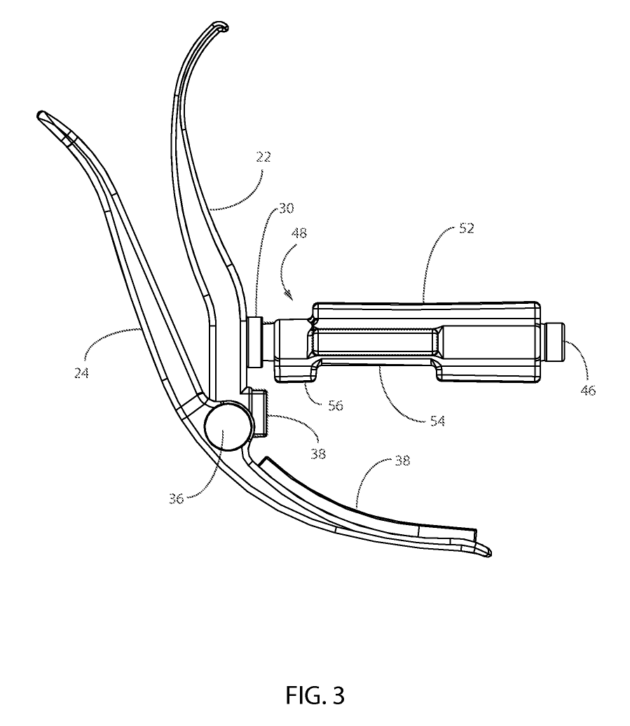

FIG. 3 shows the rotatable member 48 which is coupled to the capo stem 32 which in turn is coupled to the sus pole 26 to allow the rotatable member 48 to be rotated in either a clockwise or counter-clockwise direction. In addition, it is to be noted that a main objective of the assembly of the rotatable member 28, the capo stem 32, and the sus pole 26 is to allow the rotatable member 48 to be easily removed in order to provide other rotatable members with different capo configurations to be interchanged, thus providing potentially an unlimited amount of different capo configurations. In one embodiment, the capo configurations of the rotatable member are made of elastomeric-like pads but can be made of any suitable material for the purposes of urging the strings into the contact with the fret board of the stringed instrument. In one preferred embodiment, the rotatable member 48 has a length of 5.97 centimeters.

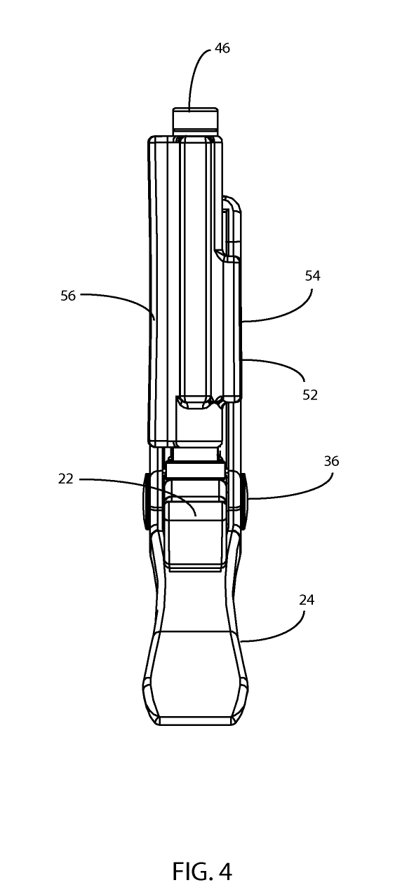

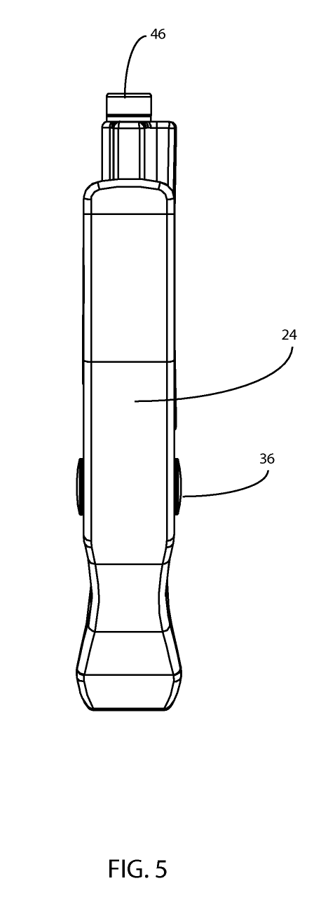

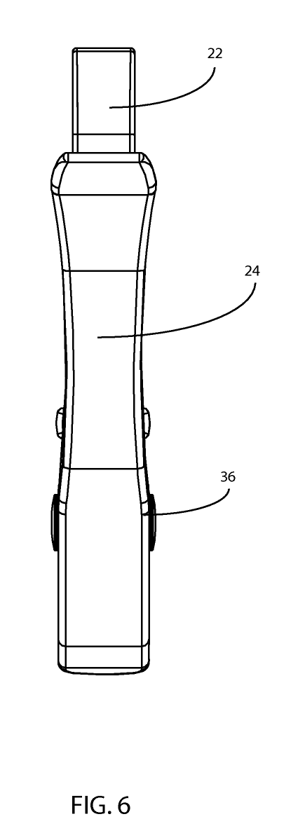

FIG. 4 depicts the width of top and bottom handles of the first portion 22 and second portion 24. FIG. 5 clearly shows the second portion 24 which are positioned against the neck of the stringed instrument. FIG. 6 shows the back of the second portion 24 which typically rests against the palm of the user's hand when attempting to squeeze both the first portion 22 and second portion 24 together which allows the capo of the inventive subject matter to open and allow the user to position the capo onto the guitar.

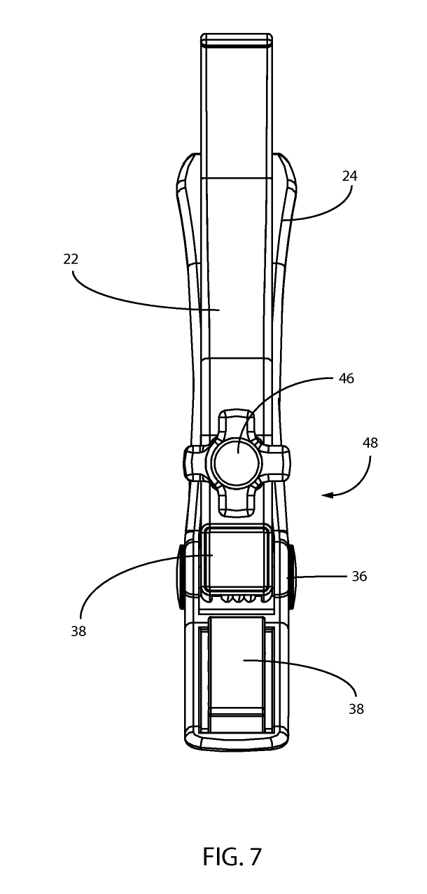

Turning to FIG. 7, a front view of the capo of the inventive subject matter is shown. In particular, the rubber pads 38 provide gripping means when the capo of the inventive subject matter is placed on the neck of the stringed instrument. In addition, the rubber pads 38 provide protection to the back and sides of the neck of the stringed instrument and prevents manning of the neck. It is to be noted that the rubber pads may be made of similar elastomeric-like material other than rubber.

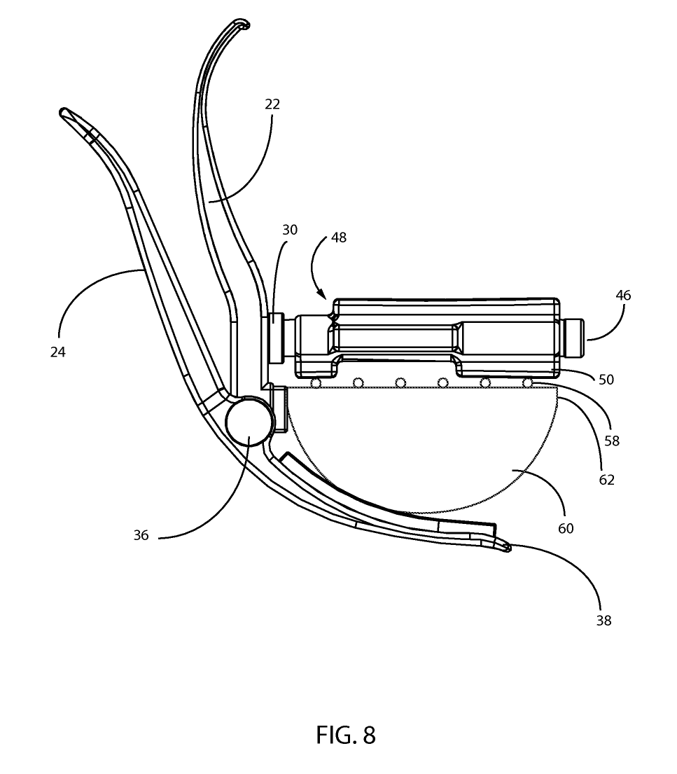

In FIG. 8, the rotatable member 48 is shown in its regular capo configuration 50. In one embodiment, the capo of the inventive subject matter is shown on a regular six string guitar with both the strings 58, neck 60 and the fret board 62 of the guitar being depicted. As seen, the regular capo configuration 50 on the rotatable member 48 covers all six strings of a regular six string guitar which are the E, A, D, G, B and E strings. The biasing means of the capo of the inventive subject matter being a tension coiled spring allows both the first portion 22 and rotatable member 48 to apply clamping pressure which urges all six strings in contact with the fret board of the guitar. The second portion 24 also applies opposite pressure to the back of the neck of the guitar which securely positions the capo of the inventive subject matter onto the guitar fret board and neck. The term “covers” when used in the description of FIGS. 8-11 is meant to describe the urging of the strings of the guitar into contact with the fret board of the guitar. In a preferred embodiment, the regular capo configuration 50 has a first ridge and preferably the ridge has a height of 0.3 centimeters, and a length of 5.71 centimeters. The ridge of the regular capo configuration 50 may be rounded off at the edges.

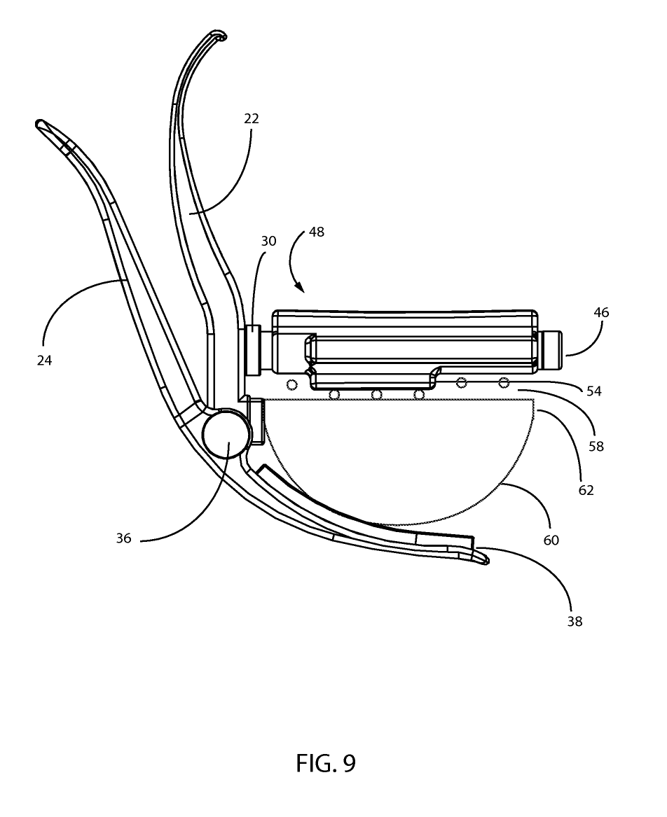

In FIG. 9, the rotatable member 48 is shown it is cut capo configuration 54 on a regular six string guitar again for illustrative purposes. Here, the cut capo configuration 54 of the rotatable member 48 is made in a way to only cover certain strings of the guitar and whereby allowing the remaining uncovered or open strings to not be urged into contact with the fret board of the stringed instrument. In one embodiment, the cut capo covers the 3, 4, and 5 strings or the A, D, and G strings on a regular tuned six string guitar. This provides for alternative tuning possibilities without having to actually re-tune the strings. In a preferred embodiment, the cut capo configuration 54 has a ridge and preferably the ridge has a height of 0.3 centimeters and a length of 2.32 centimeters. The ridge of the cut capo configuration 54 also containing a first indentation of 1.53 centimeters in length and a second indentation of 2.23 centimeters in length which are located on both sides of the ridge of the cut capo configuration 54. The ridge of the cut capo configuration 54 may be rounded off at the edges.

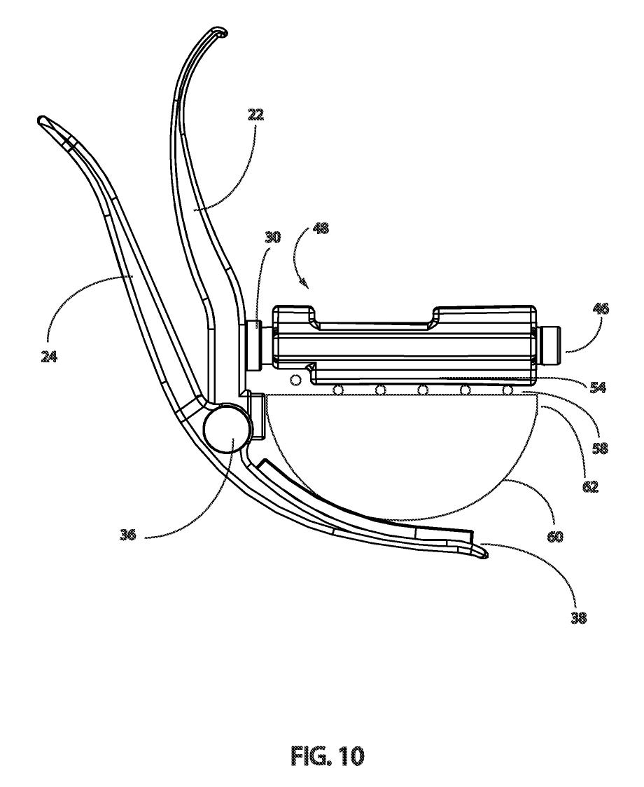

In FIG. 10, the rotatable member 48 is shown in its drop d capo configuration 52 on a regular six string guitar again for illustrative purposes. Here, the drop-d capo configuration 52 of the rotatable member 48 is made in a way to only cover certain strings of the guitar and whereby allowing the remaining uncovered or open strings to not be urged into contact with the fret board of the stringed instrument. In one embodiment, the drop-d capo configuration 52 leaves open or in other words does not urge the 6 string or low E string onto the fret board on a regular tuned six string guitar while urging the remaining strings onto the fret board of the stringed instrument. This provides for alternative tuning possibilities without having to actually re-tune the strings. In a preferred embodiment, the drop-d capo configuration 52 has a ridge and preferably the ridge has a height of 0.3 centimeters and a length of 4.36 centimeters. The ridge of the drop-d capo configuration 52 also containing an indentation of 1.49 centimeters in length. The ridge of the drop-d capo configuration 52 may be rounded off at the edges.

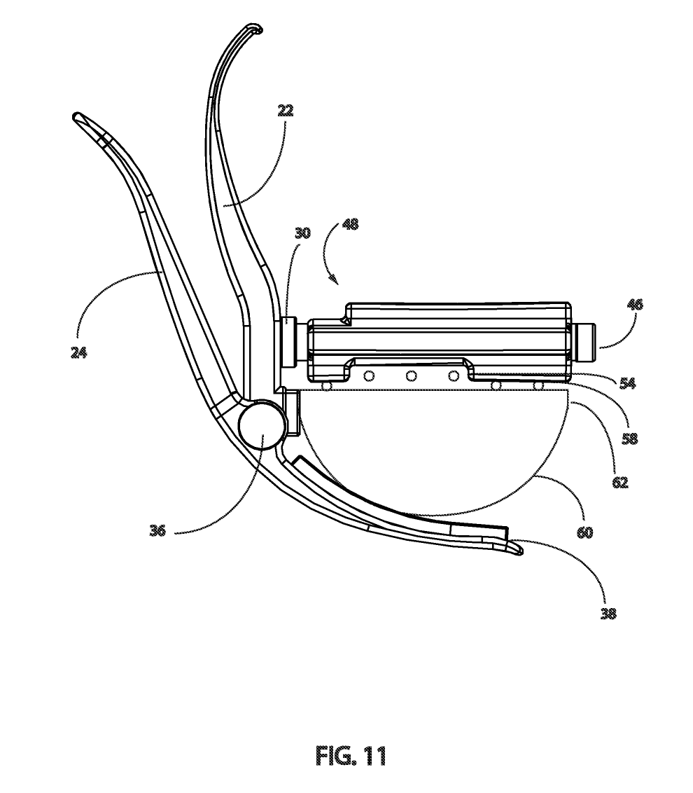

In FIG. 11, the rotatable member 48 is shown in its open capo configuration 56 on a regular six string guitar again for illustrative purposes. Here, the open capo configuration 56 of the rotatable member 48 is made in a way to only cover certain strings of the guitar and while leaving other strings uncovered. In one embodiment, the open capo leaves open or uncovered the 3, 4, and 5 strings or the A, D and G strings while urging the remaining strings onto the fret board of the stringed instrument. This provides for alternative tuning possibilities without having to actually re-tune the strings. In a preferred embodiment, the open capo configuration 56 has a first ridge and a second ridge. Preferably the first ridge has a height of 0.3 centimeters and a length of 2.23 centimeter and the second ridge has a height of 0.3 centimeters and a length of 0.94 centimeters. The ridge of the open capo configuration 56 also containing an indentation of 2.32 centimeters in length in between both ridges. The ridge of the open capo configuration 56 may be rounded off at the edges.

It is noted that in another embodiment, each capo configuration does not require a raised ridge whereby the rotatable member 48 being comprised of a whole cylinder with indentations.

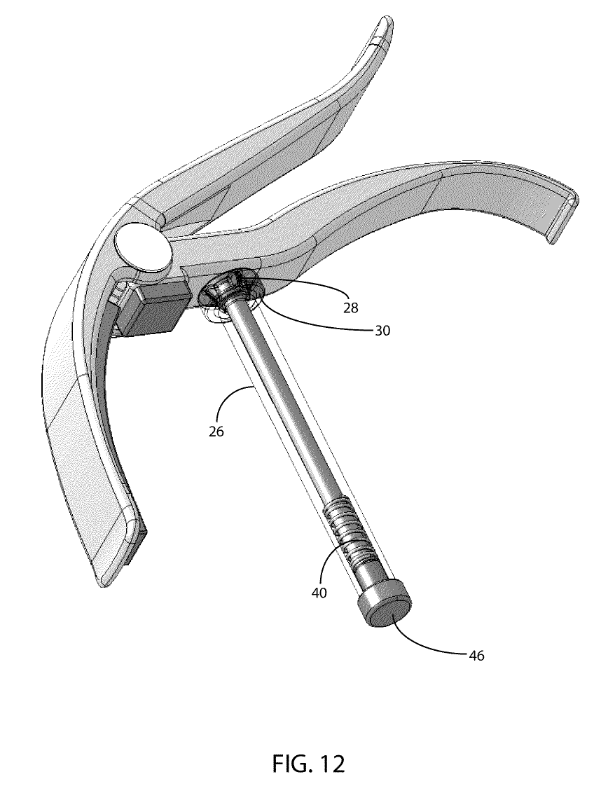

In FIG. 12, a close up view of the locking mechanism is shown. In particular, it shows the locking mechanism 30 which is on one end of the capo stem 32 fitting directly over the locking protrusion with cross ribs 28 which is coupled to the first portion 22. When in locked position, the cross ribs of the locking protrusion 28 fits within the corresponding recesses in the locking mechanism 30 which prevents unwanted movement or rotation of the rotatable member 48.

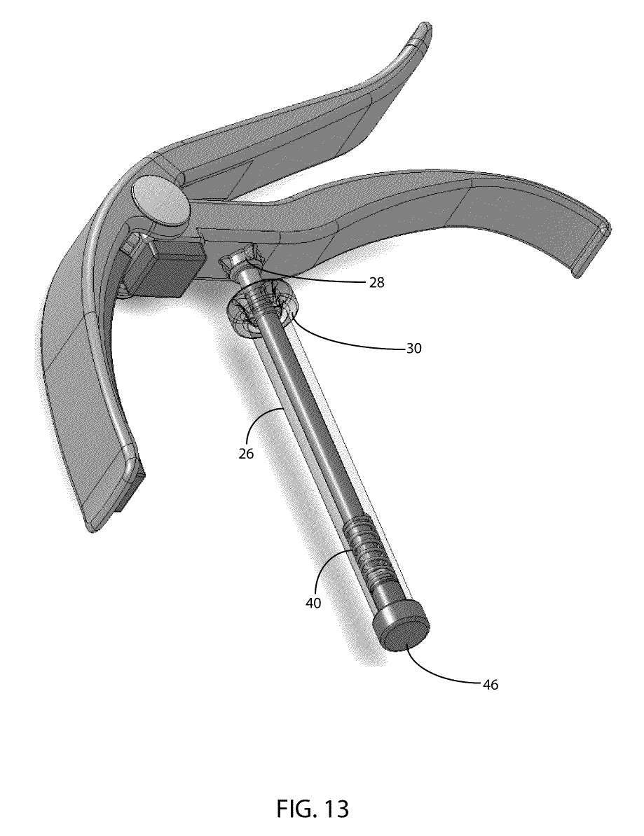

In contrast, FIG. 13 shows the locking mechanism 30 in an unlocked position. In one embodiment, the rotatable member 48 can be placed in its unlocking position by pulling the rotatable member 48 away from the first portion and which engages the tension coiled spring 40. By doing this, the cross ribs 28 of the locking protrusion becomes disengaged from the corresponding recesses within the locking mechanism 30 and which allows the user the ability to rotate the rotatable member 48 to select the desired capo configuration. Once the desired capo configuration is selected, the user would simply just let go of the rotatable member 48 resulting in the biasing means pressure from the tension coil spring 40 to urge the locking mechanism 30 back into locking position on the cross ribs 28 of the locking protrusion.

Thus, specific embodiments and applications of the capo of the inventive subject matter for stringed musical instruments have been disclosed. It should be apparent, however, to those skilled in the art that many more modifications besides those already described are possible without departing from the inventive concepts herein. The capo of the inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components or steps may be present, or utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc.

What is claimed is:

1. A capo for a guitar having strings, said capo comprising:
A first portion;
A rotatable member connected to the first portion and extends above the strings when attached to the stringed instrument to urge at least one string into contact with one fret of said stringed instrument;
a second portion pivotably connected to the first portion to engage a back of a neck of said stringed instrument;
a spring to bias the rotatable member towards a end of the rotatable member;
wherein said rotatable member is comprised of a first capo configuration disposed on a first side to urge six strings into contact with at least one fret of said stringed instrument;
wherein said rotatable member is comprised of a second capo configuration disposed on a second side to urge three strings into contact with at least one fret of said stringed instrument;
wherein said rotatable member is comprised of a third capo configuration disposed on a third side to urge five strings into contact with at least one fret of said stringed instrument;
wherein said rotatable member is comprised of a fourth capo configuration disposed on a fourth side to urge at least three strings into contact with at least one fret of said stringed instrument; and
wherein user-selective rotation of the rotatable member along a longitudinal axis allows only one of the four capo configurations to urge the strings at a single time.

2. A capo as recited in claim 1 wherein the rotatable member is interchangeable with another rotatable member having different capo configurations.

3. A capo for use with a stringed instrument having strings, said capo comprising:
a first portion;
a rotatable member that extends above the strings and urging said strings into contact with at least one fret of said stringed instrument;
a second portion that engages the back of the neck of said stringed instrument;

4. The capo of claim 1 wherein said rotatable member consists of at least one capo configuration which urges certain strings into contact with at least one fret of said stringed instrument;

5. The capo configuration of claim 2 wherein each capo configuration is comprised of an elastomeric-like pad;

6. The capo of claim 1 wherein each said capo configuration can be selected to urge the strings into contact with the neck by turning said rotatable member until a particular capo configuration is selected;

7. The capo of claim 1 containing a locking mechanism which allows the user to selectively lock and unlock the rotating member in a selected position;

8. The capo of claim 1 including a biasing means for allowing said first portion and said second portion to apply pressure on said fret and said neck of said stringed instrument resulting in urging the strings into contact with the fret of the stringed instrument;

9. The biasing means of claim 8 comprising a tension coiled spring;

10. The first portion of claim 1 comprising a first handle portion;

11. The second portion of claim 1 comprising a second handle portion;

12. The capo of claim 1 comprising of a pivotal connection to pivotally interconnect said first portion to said second portion such that both can be pivoted relative to each other in order to, in use, fit and position the strings and neck between said portions;

13. The capo of claim 1 wherein the rotatable member is interchangeable with other rotatable members which contain different capo configurations.

14. A capo for a guitar comprising:
a first portion;
a member that extends above the strings and urging said strings into contact with at least one fret of said stringed instrument;
a second portion that engages the back of the neck of said stringed instrument;
said member consisting of at least two capo configurations;

15. The capo of claim 14 wherein said member is rotatable;

16. The capo of claim 14 wherein each said capo configuration comprises of an elastomeric-like pad which urges certain strings into contact with at least one fret;

17. The capo of claim 14 wherein each said capo configuration can be selected by turning said member until a particular said capo configuration is selected;

18. The capo of claim 14 containing a locking mechanism which allows the user to selectively lock and unlock the member in one position;

19. The capo of claim 14 including a biasing means for allowing said first portion and said second portion to apply pressure on said fret and said neck of said stringed instrument;

20. The biasing means of claim 14 comprising a tension coiled spring;

21. The first portion of claim 14 comprising a first handle portion;

22. The second portion of claim 14 comprising a second handle portion;

23. The capo of claim 14 comprising of a pivotal connection to pivotally interconnect said first portion to said second portion such that both can be pivoted relative to each other in order to, in use, fit and position the strings and neck between said portions;

24. A method for selecting multiple capo configurations, the method comprising:
providing a capo for use with stringed instruments;
providing a rotatable member comprising of at least one capo configuration;
wherein said capo comprising of a first portion and a second portion;

25. The method of claim 24 wherein the desired capo configuration is selected by turning the rotatable member to the desired capo configuration;

26. The method of claim 24 wherein the rotatable member is interchangeable with other rotatable members that are comprised of different capo configurations;

27. The method of claim 24 wherein said capo configuration is made of an elastomeric-like pad;

28. The method of claim 24 comprising a biasing means for allowing said first portion and said second portion to apply pressure on the fret and the neck of said stringed instrument;

29. The method of claim 24 further comprising a locking mechanism which allows the user to selectively lock and unlock the member in one position;
